(19) United States
(12) Patent Application Publication
(10) Pub. No.: US 2011/0294096 A1
(43) Pub. Date: Dec. 1, 2011

(54) Acoustic Monitoring of Oral Care Devices

(75) Inventors: Jose Tadeo Vergara deCastro, Newton Center, MA (US); Mark Edward Farrell, Medfield, MA (US); Elizabeth Jane Wenzel, West Newton, MA (US); Robert J. DiCamillo, Brookline, MA (US)

(73) Assignee: The Procter & Gamble Company, Cincinnati, OH (US)

(21) Appl. No.: 12/787,637

(22) Filed: May 26, 2010

(51) Int. Cl. A61C 17/16; H04R 3/00

(52) U.S. Cl. 433/216; 381/122; 15/105

(57) ABSTRACT

A device is disclosed for acoustically determining one or more characteristics of a powered oral care (POC) implement. The device comprises a transducer and a processor, wherein: the transducer receives sound generated by the POC implement and converts the sound into a signal representative of the sound; the transducer is in electrical communication with the processor and transmits the signal representative of the sound to the processor; and the processor determines one or more characteristics of the POC implement based on the signal representative of the sound.

### FIELD OF THE INVENTION

The present disclosure relates to oral care devices and, more particularly, to acoustically monitoring one or more characteristics of the oral care devices.

### BACKGROUND OF THE INVENTION

As background, people use oral care devices to clean their teeth. The effectiveness of the oral care device in cleaning one's teeth depends on, among other things, how the oral care device is used by that person and the duration of such use. For example, it has been established that the recommended time for brushing teeth is approximately two minutes. However, most persons do not brush their teeth for the recommended period of time. Instead of two minutes, most brush for a time period which is closer to one minute or less.

Furthermore, many people, when cleaning their teeth, may apply too much force to the brush in an effort to get the brush into hard to reach places. Unfortunately, the application of greater force to the brush results in greater pressure applied to the surface of the teeth and gums. The increased pressure against the teeth can cause premature wear in the enamel of the teeth and similarly can cause gum irritation and gum recession.

Accordingly, there is a need for automatically monitoring one's use of the oral care device and to inform the person of his brushing habits, such as the length of time for cleaning the teeth and the force or pressure applied by the user when cleaning the teeth.

### SUMMARY OF THE INVENTION

In one embodiment, a monitoring device for acoustically determining one or more characteristics of a powered oral care (POC) implement comprises a transducer and a processor, wherein: the transducer receives sound generated by the POC implement and converts the sound into a signal representative of the sound; the transducer is in electrical communication with the processor and transmits the signal representative of the sound to the processor; and the processor determines one or more characteristics of the POC implement based on the signal representative of the sound.

In another embodiment, a system comprises a powered oral care (POC) implement and a monitoring device, wherein: the POC implement cleans teeth and generates sound; the monitoring device is in acoustic communication with the POC implement and receives the sound generated by the POC implement; and the monitoring device determines one or more characteristics of the POC implement based on the sound received by the monitoring device.

In yet another embodiment, a method for determining one or more characteristics of a powered oral care (POC) implement comprises: receiving sound generated by the POC implement; identifying one or more acoustic characteristics of the sound; and determining one or more characteristics of the POC implement based on the one or more acoustic characteristics of the sound.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1 depicts a powered oral care implement and a monitoring device according to one or more embodiments shown and described herein;

FIG. 2 depicts a schematic, cross sectional representation of a powered oral care implement according to one or more embodiments shown and described herein;

FIG. 3A depicts a graphical representation of sound generated by a powered oral care implement according to one or more embodiments shown and described herein;

FIG. 3B depicts a graphical representation of sound generated by a powered oral care implement and background noise according to one or more embodiments shown and described herein;

FIG. 4 depicts a block diagram of a monitoring device according to one or more embodiments shown and described herein;

FIG. 5 depicts a block diagram of a monitoring device according to one or more embodiments shown and described herein;

FIG. 6 depicts a graphical representation of sound generated by a powered oral care implement according to one or more embodiments shown and described herein;

FIGS. 7A-C depict a method for determining one or more characteristics of powered oral care devices according to one or more embodiments shown and described herein;

FIG. 8 depicts a method for determining one or more characteristics of powered oral care devices according to one or more embodiments shown and described herein; and

FIG. 9 depicts a method for determining one or more characteristics of powered oral care devices according to one or more embodiments shown and described herein.

### DETAILED DESCRIPTION OF THE INVENTION

Before describing the various embodiments, it is instructive to define the various types of motions that the brush head may undergo. As used herein, the term “angular motion” refers to any angular displacement. “Linear motion” is movement along a straight or substantially straight, line or direction. “Curvilinear motion” is movement that is neither completely linear nor completely angular but is a combination of the two (for example, curvilinear). These motions can be constant or periodic. Constant motion refers to motion that does not change direction or path (i.e., is unidirectional). Periodic motion refers to motion that reverses direction or path. Constant angular motion is referred to as rotary motion, although features herein may be described as “rotatably mounted” which is intended to merely mean that angular motion, whether periodic or constant, is possible. Periodic angular motion is referred to as oscillating motion. Curvilinear motions can also be either constant (i.e., unidirectional) or periodic (i.e., reverses direction). Periodic linear motion is referred to as “reciprocation”. “Orbital motion” is a type of angular motion about an axis that is distinct from and is some distance apart from the center of the moving component, for example, a shaft. This distance is referred to herein as the extent of offset of the orbital motion. Orbital motion may be either constant angular motion or periodic angular motion.

The above-described motions can occur along one or more axes of a bristle carrier, a toothbrush, a toothbrush head, etc. Accordingly, motion is described herein as being either one, two, or three dimensional motion depending upon the number of axial coordinates required to describe the position of a bristle carrier during its movement. One dimensional motion is motion that can be described by a single coordinate (for example, X, Y, or Z coordinates). Typically, only linear motion can be one dimensional. For example, periodic linear motion substantially along only the Y axis is one dimensional motion (referred to herein as a “pulsing motion” or an “up and down motion”). Two dimensional motion is movement by a bristle carrier that requires two coordinates (for example, X and Y coordinates) to describe the path of travel of the bristle carrier. Angular motion that occurs in a single plane is two dimensional motion since a point on a bristle carrier would need two coordinates to describe the path of travel. Three dimensional motion is movement by a bristle carrier that requires three coordinates (for example, X, Y, and Z coordinates) to describe the path of travel of the bristle carrier. An example of three dimensional motion is movement by a bristle carrier in the path of a helix. A multi-motion toothbrush is disclosed in U.S. Patent Publication No. 2003/0084527, owned by The Procter and Gamble Company, and hereby incorporated by reference herein.

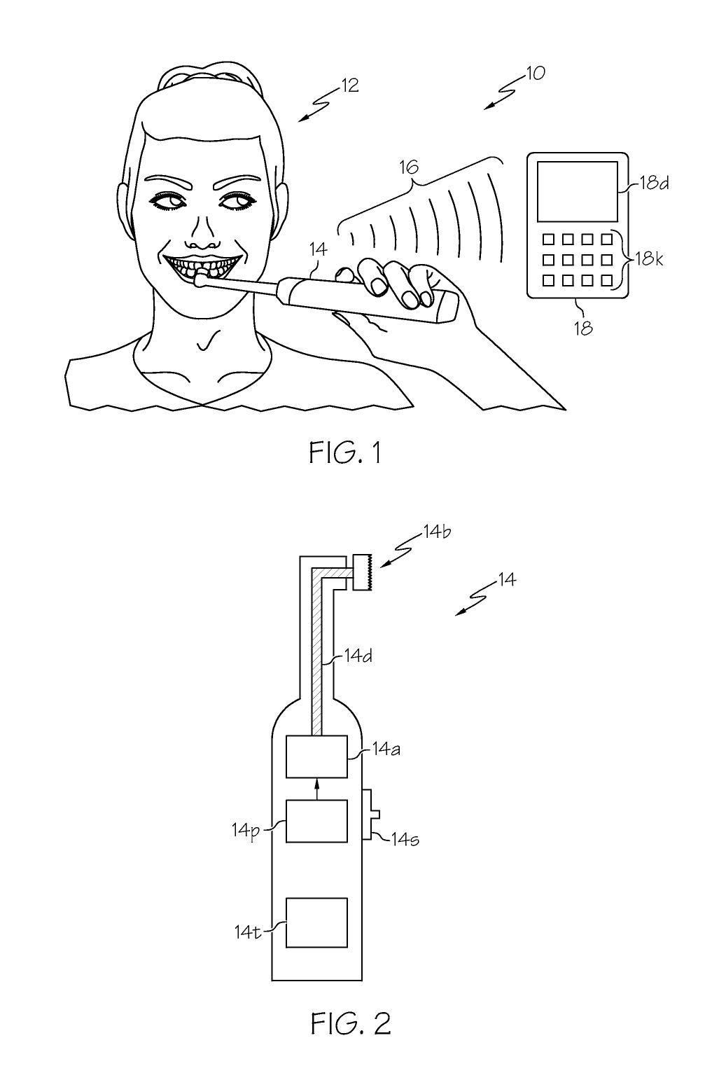

The invention is described below using powered oral care (POC) implement 14 as an example, which is shown in FIG. 1. However, acoustic monitoring as described herein also applies to additional powered implements such as electric shavers, electric handheld tools, electric kitchen appliances, electric hand-held vacuum cleaners, and electric hair dryers. FIG. 1 generally depicts one embodiment of a system 10 for acoustically monitoring a POC implement 14. A user 12 may clean his or her teeth with the POC implement 14, which may generate sound 16 (e.g., sound waves) while the POC implement 14 is being used. The system 10 includes a monitoring device 18 which receives sound 16 generated by the POC implement 14 and determines one or more characteristics of the POC implement 14 based on the sound 16. The monitoring may take place automatically and with little or no effort required by the user 12.

The types of characteristics determined by the monitoring device 18 may include, but are not limited to, whether the POC implement 14 is switched on or off, an amount of time the POC implement 14 is used to clean the user's teeth, an amount of pressure applied by the POC implement 14 to the teeth, which brushing mode the POC implement 14 is in, a manufacturer of the POC implement 14, and a model number of the POC implement 14. Other characteristics of the POC implement 14 may be determined as well. The acoustic characteristics of the sound 16 generated by the POC implement 14 may be used to determine one or more of the characteristics of the POC implement 14. Acoustics characteristics of the sound 16 may include, but are not limited to, the amplitude, frequency, change in amplitude, change in frequency, and combinations thereof.

Monitoring the characteristics of the POC implement 14 may help the user 12 improve his or her brushing habits. For example, the system 10 may help the user 12 ascertain that he or she is not brushing for the recommended time, or that the user 12 is applying too much pressure when cleaning his or her teeth. As another example, the system 10 may recommend that the user 12 install a new brush head on the POC implement 14, or that the battery in the POC implement 14 is approaching its end of life. Both recommendations may be based upon time of use determined via the monitored acoustic characteristics. Furthermore, if the characteristics are monitored and recorded over a time period (for example, one month), it may provide a history of the user's oral hygiene routines and habits. This history may be analyzed by the user 12 or by an oral care professional in order to improve the user's brushing habits and/or make recommendations.

Referring to FIG. 2, one embodiment of a POC implement 14 is shown. The POC implement 14 may include an actuator 14a, a brush head 14b, a power source 14p, and a switch 14s. The actuator 14a may produce a linear, rotational, or vibratory motion which is transferred to the brush head 14b via a drive mechanism 14d. The actuator 14a in the POC implement 14 may include an electric motor, a piezoelectric motor, electro-chemical polymer driven motor, any other suitable device, or any combination thereof. The actuator 14a may be capable of converting electrical energy (for example, from the power source 14p) into motion energy in order to operate the brush head 14b as described herein. For example, in one embodiment, the actuator 14a may be a rotary electrical motor which is capable of producing rotational motion. The actuator 14a may be coupled to the brush head 14b via a drive mechanism 14d having one or more gears, axles, belts, drive shafts, other suitable components, or any combination thereof.

As described above, the brush head 14b may undergo angular motion, linear motion or curvilinear motion and that motion may be constant or periodic when driven by the actuator 14a. The brush head 14b may rotate only, or it may rotate and move in and out of the POC implement 14 along an axis that is parallel to its axis of rotation. The brush head 14b comes into contact with the user's teeth, and the motion of the brush head 14b as it comes into contact with teeth causes the teeth to be cleaned. Tooth paste or other suitable materials may be used in conjunction with the POC implement 14 in order to improve the effectiveness of the cleaning process. The brush head 14b is typically removable and may be replaced with a new brush head when desirable or when the old one wears out.

The POC implement 14 has a power source 14p which provides energy to operate the actuator 14a. The power source 14p may permit the POC implement 14 to operate wirelessly, that is, without having a wire or a cable leading to another source of power such as, for example, a common household 110-Volt electrical outlet. The power source 14p may be, for example, a rechargeable or non-rechargeable battery. A rechargeable battery may employ lithium-ion or nickel-metal hydride technology, and a non-rechargeable battery may employ alkaline or zinc-carbon technology. Other types of rechargeable and non-rechargeable battery technologies may be used as well, including those presently known and those yet to be developed. In addition to batteries, the power source 14p may comprise other types of energy sources as well.

The POC implement 14 has a switch 14s which allows the user 12 to switch it on and off. The switch 14s may be electrically coupled to the power source 14p and to the actuator 14a such that the switch 14s is capable of connecting (for example, when “on”) or disconnecting (for example, when “off”) the power source 14p to the actuator 14a. The switch 14s may be a sliding switch, a pushbutton switch, or any type of suitable switch. Additionally, the POC implement may have an “auto-on” switch which when the user presses the brush head against their teeth, the POC implement 14 turns on. When the user pulls the POC implement 14 away from their teeth and the pressure is released, the POC implement 14 turns off.

The POC implement 14 generates sound when it is operating. The sound may be the result of the movement of any of the components which comprise the POC implement such as, for example, the actuator 14a, the brush head 14b, the drive mechanism 14d, and the switch 14s. As discussed herein, the drive mechanism 14d may contain gears and/or other suitable items, some or all of which may individually generate sound when the POC implement 14 is operating. Furthermore, sound may be generated by the movement of the brush head 14b as it contacts the teeth during the cleaning process. Thus, the sound generated by the POC implement 14 may be the collective result of the sound generated by some or all of the individual components which make up the POC implement 14.

The POC implement 14 may also comprise a dedicated acoustic device 14t which is capable of generating sound. The dedicated acoustic device 14t may be a speaker, a buzzer, a piezoelectric transducer, other suitable device, or any combination thereof. The purpose of the dedicated acoustic device 14t may be to generate sound encoded with information from the POC implement 14 which can by received by the monitoring device (for example, monitoring device 18 of FIG. 1). The information may include, for example, when the POC implement 14 is switched on and off, an amount of time the POC implement 14 is used to clean the teeth, an amount of pressure applied by the POC implement 14 to the teeth, which brushing mode the POC implement 14 is in, the manufacturer of the POC implement 14, and the model number of the POC implement 14. Other types of information may be encoded as well. The encoding of the information may be performed using digital techniques (for example, on-off keying) or analog techniques (for example, amplitude or frequency modulation). For example, the dedicated acoustic device 14t may employ on-off keying to transmit digital information to the monitoring device. In this example, the dedicated acoustic device 14t may transmit an acoustic signal at 10 kHz which is rapidly turned on (i.e., a logic “1”) and off (i.e., a logic “0”) so as to create a digital stream of data containing the information. Other methods of encoding information may be used as well.

If the POC implement 14 has a dedicated acoustic device 14t, the dedicated acoustic device 14t may be exclusively used to acoustically transmit information about the POC implement 14 to the monitoring device. That is, in this embodiment, the monitoring device may only recognize sound generated by the dedicated acoustic device 14t. In another embodiment, the monitoring device may recognize both sound generated by the dedicated acoustic device 14t as well as sound generated by the other components of the POC implement 14 as described above. For purposes of this disclosure, sound generated by the POC implement 14 includes sound generated by the dedicated acoustic device 14t (if it is used) as well as sound generated by the other components of the POC implement 14 (for example, actuator 14a, brush head 14b, refills, etc.), unless otherwise indicated. For example, in one embodiment, the actuator 14a could modify its sound, for example by “stuttering”, in order to generate sound encoded with information which can be received by the monitoring device. In another embodiment, each category or type of brush head 14b for use with POC implement 14 could have a unique sound which can be transmitted to the monitoring device to alert the monitoring device that a new or different brush head is in use. In one embodiment, the unique sound may be delighting to the user. In another embodiment, the unique sound may be brand-identifiable to the user.

Referring again to FIG. 1, the monitoring device 18 may include any smart device, including but not limited to, smart phones, personal digital assistants, netbooks, GPS devices, tablets, e-readers, iPads, mobile gaming consoles (for example, Nintendo DS, Nintendo DSi XL, Sony PSP), personal computers, mp3 players, iPods or a dedicated monitoring apparatus. The term “smart device” refers to any portable device capable of running one or more software applications. Smart devices also can be connected to the Internet or one or more computer networks. For example, the monitoring device 18 may include a Blackberry® or iPhone® brand of smart phones. Other types of monitoring devices may be used as well, including those currently available and those yet to be developed. The monitoring device 18 may also be a dedicated monitoring apparatus, which has been developed specifically for use with POC implements. For example, the POC implement 14 and the dedicated monitoring apparatus may be developed and sold together. Alternatively, the monitoring device 18 may be incorporated into a base for charging the battery of the POC implement 14 when it is not being used. In short, it is contemplated that many types of apparatuses that are operable to receive the sound(s) generated from the POC implement 14 may be used as the monitoring device 18. The monitoring device 18 may have a display 18d which permits characteristics (for example, the amount of brushing time) of the POC implement 14 to be displayed to the user 12. The monitoring device 18 may also have keys 18k or any other type of input interface which allow the user 12 to enter information or to inform the monitoring device 18 that the user 12 is ready to brush his or her teeth.

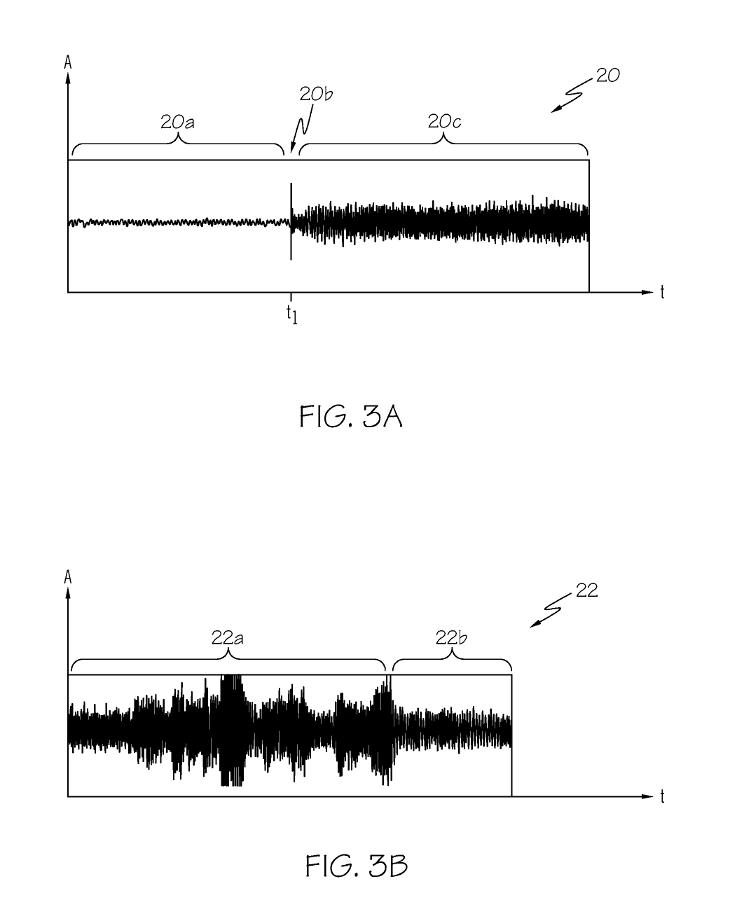

Referring to FIG. 3A, a graph 20 depicts sound generated by a POC implement over time. The vertical axis “A” represents the amplitude of the sound, while the horizontal axis “t” represents time. During time 20a, the POC implement is not operating and thus there is no sound shown as being generated by the POC implement 14. However, as shown there is a little background noise being received. For purposes of this disclosure, “background noise” is sound generated from sources, other than the POC implement, which can be received (i.e., “heard”) by the monitoring device. For example, because most people brush their teeth in the bathroom, background noise could include sound from water running in a sink, sound from a toilet flushing, or sound from a shower or bath running. Furthermore, background noise could include other people talking or a radio playing. It is understood that there may also be times where there is no background noise received by the monitoring device. Thus, the sound received by the monitoring device may be a mixture of sound generated by the POC implement and the background noise. As discussed herein, the monitoring device may be configured to analyze the sound it receives in order to ascertain certain acoustic characteristics of the sound. This may allow the monitoring device to determine one or more characteristics of the POC implement.

Referring still to FIG. 3A, at time 20b, the POC implement is switched on, at which time there is a quick spike or an increase in the amplitude of the sound. This spike or transient at time 20b may be caused by movement of the switch or by the movement of the actuator, drive mechanism, or brush head at the moment the actuator begins to operate. The spike may have a unique frequency signature that could be detected by the monitoring device. During time 20c, the POC implement is operating and thus generating sound at a relatively constant amplitude.

Referring to FIG. 3B, a graph 22 depicts sound generated by a POC implement mixed with background noise. The vertical axis “A” represents the amplitude of the sound, while the horizontal axis “t” represents time. During time 22a, the POC implement is operating, but background noise is present (for example, from a person speaking or from turning on and off a light switch) which has a higher amplitude than the sound generated by the POC device. During time 22b, the background noise is reduced, and the sound generated by the POC implement is the primary sound received by the monitoring device. Thus, the monitoring device may be configured to measure the increase in amplitude of sound caused by a POC implement being switched on and left operating, both when the amplitude of the background noise is higher and lower than the amplitude of the sound generated by the POC implement.

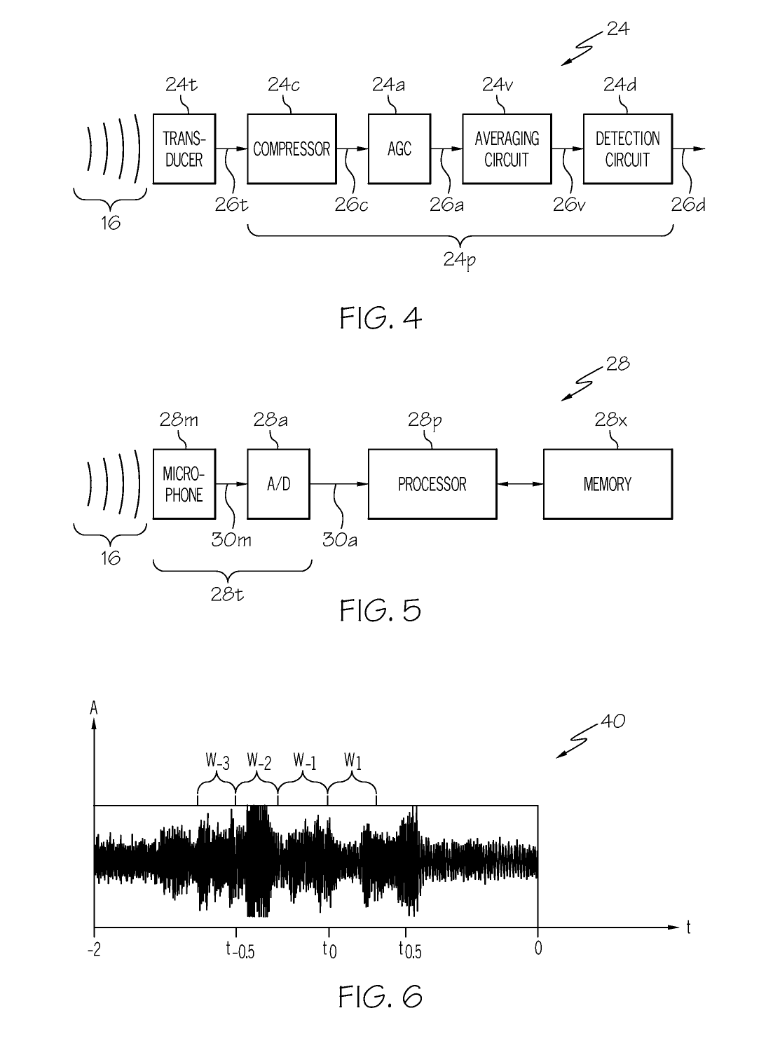

FIG. 4 depicts a block diagram 24 of a monitoring device (for example, the monitoring device 18 of FIG. 1) according to one embodiment. The monitoring device may include a transducer 24t and a processor 24p. The transducer 24t is capable of receiving sound 16 generated by the POC implement (not shown) and converting the sound to a signal 26t representative of the sound 16. The transducer 24t may be a microphone or any other suitable device. In this embodiment, the transducer 24t may convert sound 16 into an analog signal which is transmitted to the processor 24p.

The processor 24p may include a compressor 24c, an automatic gain control 24a, an averaging circuit 24v, and a detection circuit 24d. In certain embodiments, the compressor 24c may be a dynamic range compressor and be operable to compensate for transient background noise having a relatively large amplitude. The compressor 24c may receive the signal 26t (representative of the sound) from the transducer and produce a compressed signal 26c such that the compressor 24c attenuates the amplitude of the signal 26t when it is above a compressor threshold. This may permit the compressor 24c to reduce background noise spikes, such as speech and so forth. The compressor threshold may be set by the manufacturer of the monitoring device, or it may be set by the user in the location in which the monitoring device will be used via a calibration routine (discussed herein). In one embodiment, the compressor threshold may be −10 dB (decibels).

In addition to the compressor threshold, the compressor 24c may also have a corresponding attack time, which is the time the compressor 24c takes to react to a signal transitioning from below to above the compressor threshold. Likewise the compressor 24c may also have a corresponding release time, which is the time the compressor 24c takes to react to a signal transitioning from above to below the compressor threshold. Both the attack time and release time may be from about 10 to about 50 milliseconds, in another embodiment from about 20 to about 40 milliseconds and in another embodiment from about 25 to about 35 milliseconds. In one embodiment, the attack time is about 38 milliseconds, and the release time may be about 49 milliseconds. The compressor 24c may permit signals to pass through unattenuated if they are below the compressor threshold. However, as set forth above, in some embodiments herein, the compressor 24c attenuates signals above the compressor threshold. The attenuation may be linear or non-linear, and the compressor 24c may attenuate the signal based on how far the signal rises above the compressor threshold. In one embodiment, the attenuation is about 20-30:1 when the signal exceeds the compressor threshold.

The automatic gain control 24a (or AGC 24a) receives the compressed signal 26c and produces a gain-adjusted signal 26a such that an amplitude of the gain-adjusted signal 26a is within an AGC amplitude range based on an AGC time period. As compared to the compressor 24c, the AGC 24a may have a relatively long response time. In one embodiment, the AGC time period may be on the order of about 5 to about 7 seconds. This means that the AGC 24a adjusts its gain based on the average amplitude of the compressed signal over the previous 5 to 7 seconds. The AGC 24a linearly amplifies or attenuates the compressed signal so that the average amplitude of its output (i.e., the gain-adjusted signal 26a) falls within an AGC amplitude range. The AGC 24a may help compensate for weakness or strength of the sound generated by the POC implement due to its location with respect to the transducer of the monitoring device. The further the POC implement is from the transducer, the higher the gain of the AGC 24a. Thus, the AGC 24a produces a gain-adjusted signal 26a which has a relatively constant amplitude, independent of the location of the POC implement and the amplitude of the background noise.

The averaging circuit 24v receives the gain-adjusted signal 26a from the AGC 24a and produces an average amplitude 26v of the sound based on an averaging time period, which may be about 200 milliseconds in one embodiment. Thus, the averaging circuit 24v responds more quickly than the AGC 24a which, in one embodiment, is about 10 times faster.

The detection circuit 24d receives the average amplitude 26v generated by the averaging circuit 24v and determines whether the POC implement is switched on by determining whether the average amplitude exceeds an amplitude threshold for at least a minimum threshold duration period. In one embodiment, the amplitude threshold is about −108 dB, and the minimum threshold duration period is about 876 milliseconds. That is, the average amplitude 26v must remain above about −108 dB for at least about 876 milliseconds in order for the processor to determine that the POC implement has been switched on. If the average amplitude 26v ever falls below this amplitude threshold, then the processor determines that the POC implement has been switched off. It is contemplated that other embodiments may use a different amplitude threshold and/or minimum threshold duration period.

The block diagram 24 of the monitoring device shown in FIG. 4 is considered an analog circuit since all of its components operate primarily with analog values. This analog circuit can process the acoustic signals going forward in time and looking for successive peaks. This analog circuit also operates in the time domain since the frequency of the acoustic signal from the POC implement (as well as the background noise mixed therewith) is not used.

Although the block diagram 24 of FIG. 4 depicts the sound propagating to the compressor 24c, the AGC 24a, the averaging circuit 24v, and the detection circuit 24d, other topologies may be used as well. In particular, the disposition of the AGC 24a and the compressor 24c may be altered. In one embodiment, the AGC 24a may precede the compressor 24c. In another embodiment, the AGC 24a and the compressor 24c may operate in parallel, and their respective outputs may be summed before being transmitted to the detection circuit 24d. It is contemplated that other arrangements of processor's components may be used as well.

Other components may be added to the transducer 24t or the processor 24p in order to facilitate the operation of the monitoring device. For example, a band-pass filter may be added between the transducer 24t and the compressor 24c in order to remove background noise which is outside the frequency range of the sound produced by the POC implement. As another example, one or more gain multipliers may be added to the transducer 24t or the processor 24p in order to suitably scale the signal. This may include amplifying the signal (i.e., the gain multiplier is greater than 1) or attenuating the signal (i.e., the gain multiplier is less than 1). For instance, a gain multiplier may be added between the averaging circuit 24v and the detection circuit 24d. It is contemplated that other types of devices or circuits may be added to the monitoring device, as are known in the art.

FIG. 5 depicts a block diagram 28 of a monitoring device (for example, the monitoring device 18 of FIG. 1) according to another embodiment. The monitoring device of this embodiment comprises a transducer 28t and a processor 28p. The transducer 28t is capable of receiving sound 16 generated by the POC implement (not shown) and converting the sound to a signal representative of the sound 16. The transducer 28t may include a microphone 28m and an analog-to-digital converter 28a. The microphone 28m may convert the sound 16 into a signal 30m which is transmitted to the analog-to-digital converter 28a. The analog-to-digital converter 28a may convert the signal 30m, which may be an analog signal (for example, an analog voltage signal), into a digital signal 30a which is transmitted to the processor 28p. The analog-to-digital converter 28a may be 12-bit, 16-bit, or any other suitable device. The digital signal 30a may comprise a serial or parallel signal. For example, the analog-to-digital converter 28a may transmit a serial signal to the processor 28p in the form of a Serial Peripheral Interface (SPI) Bus. Other types of serial or parallel buses may be used as well.

The processor 28p may be a computer, a microprocessor, a microcontroller, a digital signal processor, or any other suitable processor which is capable of receiving the digital signal 30a from the analog-to-digital converter 28a and determining one or more characteristics of the POC implement based on the digital signal 30a. This determination may be embodied in a computer program which is read and executed by the processor 28p. The computer program may be stored in a memory 28x which is electrically coupled to the processor 28p. The computer program may comprise computer-readable and computer-executable instructions which embody one or more of the algorithms or methods shown and described herein to analyze the digital signal 30a and determine one or more characteristics of the POC implement based thereon.

The processor 28p is capable of performing a variety of algorithms in the time domain, frequency domain, or both. As discussed above, the algorithms (for example, the methods) may be embodied in computer instructions which are executed by the processor 28p. It is also contemplated that the processor 28p may perform one or more algorithms in order to determine one or more characteristics of the POC implement. The one or more algorithms may be executed by the processor in parallel or in series.

The processor 28p may be capable of storing the digital signal 30a (which represents the sound generated by the POC implement) in the memory 28x such that the processor 28p can keep a history of the digital signal 30a from the present time to some time in the past. The length of this history can vary and can, for example, be about 10 seconds. That is, the processor 28p may store the history of the digital signal 30a from the present time to a time about 10 seconds in the past. This may comprise a number of samples of the digital signal. As a new sample of the digital signal 30a is transmitted to the processor 28p, the oldest sample in the history may be overwritten so that the history always has the most recent samples of the digital signal 30a. The length of the history may be adjusted based on the types of algorithms performed or based on the amount of memory 28x available. The algorithms executed by the processor 28p may able to analyze the history and determine one or more characteristics of the POC implement based on this history (which, of course, represents a history of the sound generated by the POC implement as well as any background noise).

Because the processor 28p may keep a history of the digital signal 30a, the algorithms executed by the processor 28p may select a specific point in time in that history, called the “analysis time,” in order to analyze the digital signal 30a. For example, if the history has a length of 10 seconds, the algorithm could set the analysis time to the present time and analyze the previous 10 seconds of the digital signal 30a. Alternatively, the algorithm could set the analysis time to any time within the history. For example, the algorithm could set the analysis time to 5 seconds in the past, in which case the processor has 5 seconds of “historical data ” (i.e., from 10 seconds in the past to 5 seconds in the past) and 5 seconds of “future data ” (i.e., from 5 seconds in the past to the present) to analyze. If different algorithms are used by the processor 28p to analyze the history of the digital signal 30a, each algorithm may use a different analysis time. For example, a first algorithm may use the present time as the analysis time, and a second algorithm may use a time of 2 seconds in the past as the analysis time.

In addition to setting an analysis time, the algorithms executed by the processor 28p may be capable of defining one or more “time windows” which may comprise a continuous portion of the history of the digital signal 30a. For example, the algorithm may define a window as 1 second, that is, one continuous second of digital signal 30a data. If the history is 10 seconds in length, there are 10 one-second windows in the history. Depending upon the signal, reference points for analysis may be chosen such that some time windows may be analyzed in the relative past and some in the relative future. Depending on the analysis time, some windows may be in the past (i.e., historical data) and some may be in the future (i.e., future data). As described herein, the algorithms may analyze a series of time windows in order to ascertain one or more acoustic characteristics of the sound generated by the POC implement.

The monitoring device of FIG. 5 may be capable of digitally processing and analyzing acoustic signals. For example, the monitoring device may be capable of detecting the peak values of the sound; that is, it can measure acoustic characteristics of the sound in the time domain. However, by processing the acoustic signals digitally, it is also possible to analyze the individual frequency components of the signals. When analyzing sound generated by the POC implement, the monitoring device can analyze the temporal peaks of the signals, the frequency components of the signals, or both. The analysis can ultimately use any combination of characteristics (in the time and/or frequency domains) to determine one or more characteristics of the POC implement.

The sound generated by the POC implement may comprise a sum of discrete sine waves, each having a particular frequency, amplitude, and phase (for example, a Fourier series). Thus, the monitoring device may use a Discrete Fourier Transform (DFT) and/or the Fast Fourier Transform (FFT) to analyze the acoustic signals by converting them into a series of frequencies. The DFT and FFT may be implemented in computer-readable and computer-executable instructions (for example, software) which are executed by the processor. After using the DFT and FFT to decompose the acoustic signal into a series of discrete frequency components, the relative amplitudes of the frequency components may be analyzed in order to determine the one or more characteristics of the POC implement. This may include the presence or absence of a particular frequency or frequency range. For example, if the POC implement, when operating, always generates sound at a particular frequency, then the presence of this particular frequency may be used to ascertain that the POC implement is operating (i.e., switched on). In addition to detecting the presence or absence of a particular frequency in the acoustic signals, the change in amplitude at a particular frequency may also contain information about one or more characteristics of the POC implement.

Also, specific forms of frequency processing may include signature detection or matching. This may include matching how the frequency strength has changed over time (i.e., by extracting amplitude information). Other types of acoustic characteristics which may be detected and analyzed include, for example: 1) the attack time of the on-transient (for example, measured in milliseconds); 2) the frequency spectrum of the on-transient (for example, measured in Hertz); 3) the frequency spectrum of the steady state actuator (for example, a motor) at a fixed speed without any variations in the speed; 4) individually resolvable frequencies detected in the steady-state at a fixed speed via pitch detection (for example, measured in Hertz); and 5) a quantifiable variation or lack of individually resolvable frequencies (for example, measured in Hertz). For examples 1 through 4 set forth above, a frequency signature could be matched in order to detect one or more characteristics of the POC implement. For example 5 set forth above, a change in the frequency and/or amplitude could be detected. The result of one or more of these algorithms may be combined (for example, summed) in order to detect one or more characteristics of the POC implement. These and other acoustic characteristics may be analyzed, as is known in the art.

FIG. 6 depicts a graph 40 of sound generated by a POC implement mixed with background noise. The vertical axis “A” represents the amplitude of the sound, while the horizontal axis “t” represents time. The example reference time (in the signal history) for analysis is denoted on the time axis at t=0. The graph 40 shows 2 seconds of the digital signal, from t=−2 to t=0, which may be stored by the processor as the history of the digital signal. An algorithm executed by the processor may set the analysis time to t=t₀, which may be about one second in the past (with respect to the current time). Thus, the time t=t_{0.5} may be 0.5 seconds in the future with respect to the analysis time t₀, and the time t=t₅ may be 0.5 seconds in the past with respect to the analysis time t₀, although both are in the past with respect to the present time.

FIG. 6 also depicts four time windows, each of which is 0.25 seconds in duration. Time windows w₋₁, w₋₂, and w₋₃ lie in the past with respect to the analysis time t₀. Time window w₁ lies in the future with respect to the analysis time t₀. As discussed herein, the time windows may have other durations as well, and specific algorithms may define their own time windows which may be different from each other. One or more analyses may be performed on each time window, and the results from repeating the same analysis per time window can subsequently be averaged over a convenient time. Varying the window size (for example, the number of samples per window), and the subsequent averaging or weighting of results over multiple time windows allow a detection process to be better fitted (i.e., calibrated to) specific characteristics of the signal.

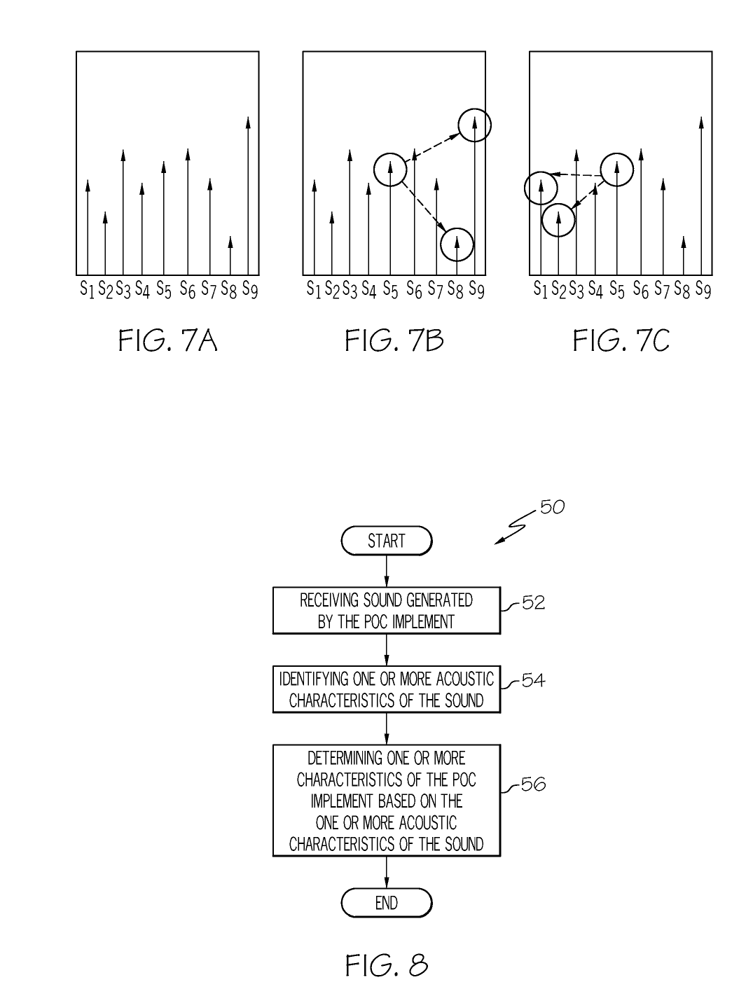

FIGS. 7A-C depict an example of an analysis which may be performed on one or more time windows. Specifically, FIG. 7A shows a number of sound samples (i.e., samples S₁-S₉ along the horizontal axis) captured within a single time window. For example, an analysis may determine the average amplitude of the signal within the time window. This may allow the system to recognize the attack (for example, onset) portion of a signal by searching for a certain number of consecutive peaks within a certain amplitude range. Any sample within this time window could be an analysis time against which the amplitude of previous or future samples would be compared. For example, FIG. 7B shows how the sample at the analysis time (S₅) is compared to future samples (S₈, S₉) within the same time window. Likewise, FIG. 7C shows how the sample at the analysis time (S₅) is compared to past samples (S₁, S₂) within the same time window. This comparison may allow the system to determine one or more characteristics of the POC implement. For example, if the comparison shows that the amplitude increased by a minimum amount, the system may assume that the POC implement was switched on during that time window. Other types of comparisons and analyses may be used as well.

FIG. 8 depicts a flow diagram 50 of one embodiment of a method for determining one or more characteristics of a POC implement. The method may be executed on a processor, such as the one shown in FIG. 5 and described herein. The method may comprise a number of steps which may be performed in any suitable order. Step 52 of the method comprises receiving sound generated by the POC implement. This may include background noise as well. Step 54 of the method comprises identifying one or more acoustic characteristics of the sound such as, for example, time-domain and/or frequency-domain characteristics. And step 56 of the method comprises determining one or more characteristics of the POC implement based on the one or more acoustic characteristics of the sound. As discussed with respect to FIG. 5, the method may be embodied in computer-readable and computer-executable instructions which are read and executed by the processor. The method may comprise software algorithms and subroutines, as is known in the art.

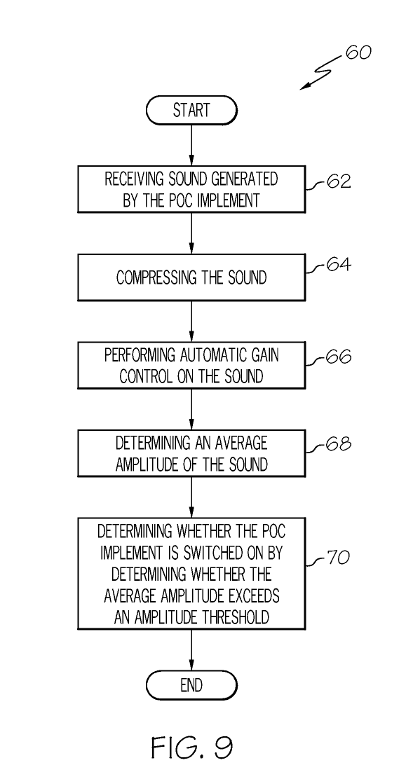

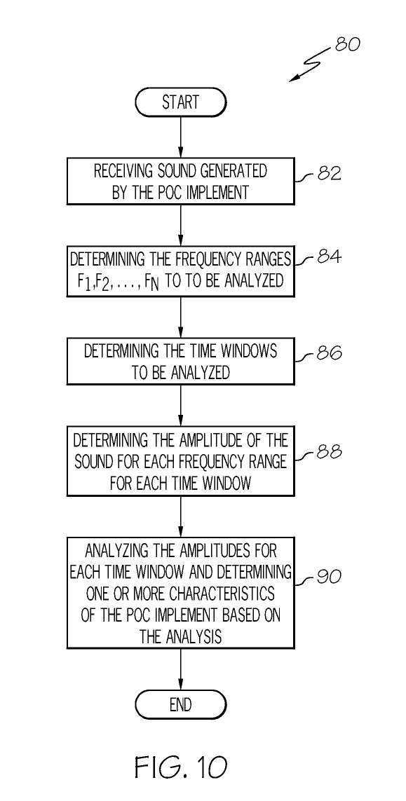

FIG. 9 depicts a flow diagram 60 of another embodiment of a method for determining one or more characteristics of a POC implement. This method may be analogous to the block diagram of FIG. 4 and may be implemented as a time-domain algorithm since it only depends upon time-based characteristics of the sound. The flow diagram 60 of FIG. 9 may comprise a number of steps implemented in (analog) hardware using amplifiers and so forth. The flow diagram 60 may also be embodied in computer readable and computer-executable instructions which are read and executed by the processor as shown in FIG. 5. Step 62 of the method comprises receiving sound generated by the POC implement. This may include background noise as well. Step 64 of the method comprises compressing the sound such that the amplitude of the sound is attenuated when it is above a compressor threshold. Step 66 of the method comprises performing an automatic gain control (AGC) function on the sound. At this step, the amplitude of the sound is adjusted so that it falls within an AGC amplitude range based on and AGC time period. Step 68 of the method comprises determining an average amplitude of the sound based on an averaging time period, which may be 200 milliseconds in one embodiment. Finally, step 70 of the method comprises determining whether the POC implement is switched on by determining whether the average amplitude exceeds an amplitude threshold for at least a minimum threshold duration period.

FIG. 10 depicts a flow diagram 80 of yet another embodiment of a method for determining one or more characteristics of a POC implement. This method may be considered a frequency-domain algorithm since it analyzes frequency-based characteristics of the sound. The flow diagram 80 of FIG. 10 may be embodied in computer-readable and computer-executable instructions which are read and executed by the processor. The flow diagram 80 may comprise a number of steps which may be performed in any suitable order. Step 82 of the method comprises receiving sound generated by the POC implement. This may include background noise as well. Step 84 of the method comprises determining the frequency components or values that will be subsequently analyzed. A range of frequencies may be denoted as F₁, F₂, . . . , F_{N}, where F₁ is the first frequency in the range, F₂ is the second frequency in the range, and so forth. Each frequency range (with its set of frequencies) may be unique, and the frequency ranges may overlap. For example, one frequency range may be about 1000 Hz to about 1200 Hz. Another frequency range may be about 800 Hz to about 900 Hz. The frequency ranges may be determined based on the frequency of sound generated by the POC implement. Because, as discussed herein, the sound generated by the POC implement may generated by its various components, the sound may have a variety of frequencies.

Step 86 of the method comprises determining the time windows that will be subsequently analyzed. As discussed herein, the monitoring device may record and store the past history of the digital signal representing the sound generated by the POC implement (including background noise), and this history may be divided into a series of time windows that may be analyzed individually. For example, 10 seconds of past history may be stored, which may be divided into 10 one-second time windows, 20 half-second time windows, or any other suitable number of time windows.

Step 88 of the method comprises determining the amplitude of the sound for each frequency range for each time window. Thus, if there are N frequency ranges, there will be N amplitudes for each time window. This step may include performing a DFT or FFT for each time window. Finally, step 90 of the method comprises analyzing the N amplitudes for each time window and determines one or more characteristics of the POC implement based on the analysis. For example, in order to determine whether the POC implement has been switched on, the analysis may be based on whether the amplitude of the F₁ frequency range increased from a lower threshold to an upper threshold for at least a minimum time period. Other analyses may be based on the change of amplitude of one or more frequency ranges. It is also contemplated that the analysis may be based on the absence of an amplitude (for example, an amplitude below a threshold) for one or more frequency ranges.

Referring again to FIG. 1, the acoustic environment in which the monitoring device 18 and the POC implement 14 are used can vary significantly. For example, the monitoring device 18 may be used in a bathroom since this is the location in which most people brush their teeth. The acoustic characteristics of the bathroom may be dependent on, inter alia, the size of the room, the construction and location of the walls, and the type and location of items (for example, rugs, decorations, and curtains) present in the room. Furthermore, the distance the monitoring device is positioned from the POC implement is also relevant. The closer the POC implement is to the monitoring device, the stronger sound signal it generates as compared to background noise. Finally, background noise can also contribute to the acoustic environment. In order to compensate for these factors and improve the operation of the monitoring device 18, a calibration procedure may be used to set some or all of the parameters of the monitoring device such as, for example, the value of the compressor threshold of the compressor shown in FIG. 4 and discussed herein. Other hardware and/or software parameters may be set as well such as, for example, the gain, sensitivity, threshold, and noise floor levels for analog or digital processing.

The calibration procedure may be relatively simple and may only have to be performed once (for example, when the POC implement 14 and monitoring device 18 are initially put into use). One example of a calibration procedure may be as follows. First, the monitoring device 18 is placed on a stable surface with the transducer (for example, microphone) pointed in the direction of the POC implement. Having the transducer as close as possible in elevation to the POC implement is preferred, but is not required since transducers typically have an omni-directional pick up pattern. Second, the POC implement is turned and held a constant distance away from the transducer for a short period of time (for example, about 10 seconds). Generally, there should be no other dominant or loud background noise at this time. And third, only the background noise (with no other loud sound) is sampled for a short period of time (for example, about 10 seconds) with the POC implement switched off. This step allows the monitoring device 18 to measure the effective combined noise of the monitoring device (for example, transducer, filter, analog-to-digital conversion, and so forth) plus the background noise of the room. These calibration steps allow the monitoring device 18 to adjust the parameters based on the acoustic characteristics of the room in which the monitoring device 18 will be used. These parameters may be stored in memory of the monitoring device 18 and may be subsequently used when the monitoring device 18 is used to determine one or more characteristics of the POC implement.

During the calibration procedure, the monitoring device 18 may adjust one or more parameters in order to improve the operation of the components (i.e., hardware or software) which are used to detect the acoustic characteristics of sound generated by the POC implement. For example, if the embodiment of the monitoring device 18 uses a compressor, the calibration procedure may adjust the compressor threshold, the compression ratio, the attack time, and/or the release time in order to improve the operation of the compressor. These parameters may be adjusted at the same time or in series. Likewise, if the monitoring device 18 uses an automatic gain control (AGC) circuit, the calibration procedure may adjust the rise time or the AGC amplitude range in order to improve the operation of the AGC circuit.

If the embodiment of the monitoring device 18 uses a frequency-domain algorithm, the calibration procedure may permit the monitoring device 18 to capture the frequency characteristics of the POC implement as well as the background noise. This may allow the monitoring device 18, when subsequently determining the characteristics of the POC implement, to analyze the frequencies of interest (i.e., the frequencies of sound generated by the POC implement) while ignoring other frequencies (i.e., the frequencies of the background noise).

Referring still to FIG. 1, the general operation of the POC implement 14 and monitoring device 18 are now described. When the user 12 is ready to use the POC implement 14, the user 12 may place the monitoring device 18 nearby. Alternatively, the monitoring device 18 may already be disposed in the proper position for suitably monitoring the sound generated by the POC implement 14. The user 12 may then inform the monitoring device 18 that he or she is ready to use the POC implement 14. This may be done, for example, by pressing one or more keys 18k or other type of input interface on the monitoring device 18. As an alternative, monitoring device 18 may be programmed to recognize the user's voice, and the user 12 may utter a word or phrase (for example, “start”) in order to perform this task. In another embodiment, the user 12 will “turn on” the POC implement and the monitoring device 18 will recognize the sound generated by the POC implement 14 and will “start”, i.e. when the user 12 starts brushing the monitoring device 18 will “start.”

When the monitoring device 18 has been informed that the user 12 is ready to brush his or her teeth, the user 12 may then pick up the POC implement 14 and begin brushing his or her teeth. The monitoring device 18 may then receive sound generated by the POC implement 14 and may determine one or more characteristics of the POC implement 14 using this sound generated by the POC implement 14. The sound generated by the POC implement 14 may include, as discussed herein, sound generated by its mechanical parts (e.g., actuator, brush head, etc.), sound generated by a dedicated acoustic device, or a combination thereof. Also as discussed herein, such characteristics may include how long the POC implement is used, how much pressure the user 12 applies to his or her teeth, and so forth.

After the user 12 finishes brushing his or her teeth and the monitoring device 18 has determined one or more characteristics of the POC implement 14 (for that particular brushing session), the monitoring device 18 may store these characteristics in a memory. The monitoring device 18 may store the characteristics over a long period of time (for example, one month, three months, a year, etc.) so that the monitoring device 18 maintains a history of user's brushing habits. This history may be used by the user 12 or the user's oral care professional (for example, dentist) to ascertain whether the user 12 is properly brushing his or her teeth. Based on the history, the user 12 may be able to improve his or her brushing habits in order to prevent cavities and other oral cavity (for example, mouth) or tissue (for example, gums and teeth) problems. The monitoring device 18 may also display the characteristics on the display 18d of the monitoring device 18 so that the user 12 may see them immediately. The monitoring device 18 may also be able to make recommendations to the user 12 concerning his or her brushing habits and/or the POC implement 14, itself. For example, the monitoring device 18 may recommend brushing more frequently or changing the brush head either based on acoustic characteristics of sound generated by the POC implement 14 or based on user input (for example, via the keys 18k) of when the brush head was last replace. As another example, the monitoring device 18 may be able to determine when the battery of the POC implement needs replacement.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A monitoring device for acoustically determining one or more characteristics of a powered oral care (POC) implement, the device comprising a transducer and a processor, wherein:
the transducer receives sound generated by the powered oral care (POC) implement and converts the sound into a signal representative of the sound;
the transducer is in electrical communication with the processor and transmits the signal representative of the sound to the processor; and
the processor determines one or more characteristics of the powered oral care (POC) implement based on the signal representative of the sound.

2. The device of claim 1, wherein the one or more characteristics of the powered oral care (POC) implement include at least one selected from the group consisting of:
whether the powered oral care (POC) implement is switched on or off;
an amount of time the powered oral care (POC) implement is used to clean teeth;
a contact pressure applied by the powered oral care (POC) implement to teeth;
a manufacturer of the powered oral care (POC) implement;
a model number of the powered oral care (POC) implement; and
a brushing mode of the powered oral care (POC) implement.

3. The device of claim 1, wherein the device is a smart device or a dedicated monitoring device.

4. The device of claim 1, wherein the transducer comprises a microphone, and the signal comprises an analog signal.

5. The device of claim 4, wherein the processor comprises a compressor, and an automatic gain control (AGC), an averaging circuit, and a detection circuit, wherein:
the compressor receives the signal representative of the sound and produces a compressed signal such that the compressor attenuates an amplitude of the signal when above a compressor threshold;
the AGC receives the compressed signal and produces a gain-adjusted signal such that an amplitude of the gain-adjusted signal is within an AGC amplitude range based on an AGC time period;
the averaging circuit receives the gain-adjusted signal and determines an average amplitude of the sound based on an averaging time period; and
the detection circuit receives the average amplitude and determines whether the powered oral care (POC) implement is switched on by determining whether the average amplitude exceeds an amplitude threshold for at least a minimum threshold duration period.

6. The device of claim 1, wherein the transducer comprises a microphone and an analog-to-digital converter, and the processor comprises a microprocessor, wherein:
the microphone receives the sound generated by the powered oral care (POC) implement, converts the sound to an analog signal representative of the sound, and transmits the analog signal to the analog-to-digital converter;
the analog-to-digital converter converts the analog signal to a digital signal and transmits the digital signal to the microprocessor; and
the microprocessor determines the one or more characteristics of the powered oral care (POC) implement based on the digital signal.

7. The device of claim 1, further comprising a display in electrical communication with the processor, wherein the processor transmits the one or more characteristics of the powered oral care (POC) implement to the display or recommendations based upon the one or more characteristics of the powered oral care (POC) implement.

8. A system comprising a powered oral care (POC) implement and a monitoring device, wherein:
the powered oral care (POC) implement cleans teeth and generates sound;
the monitoring device is in acoustic communication with the powered oral care (POC) implement and receives the sound generated by the powered oral care (POC) implement; and
the monitoring device determines one or more characteristics of the powered oral care (POC) implement based on the sound received by the monitoring device.

9. The system of claim 8, wherein the one or more characteristics of the powered oral care (POC) implement include at least one selected from the group consisting of:
whether the powered oral care (POC)implement is switched on or off;
an amount of time the powered oral care (POC) implement is used to clean teeth;
an amount of pressure applied by the powered oral care (POC) implement to teeth;
a manufacturer of the powered oral care (POC) implement;
a model number of the powered oral care (POC) implement; and
a brushing mode of the powered oral care (POC) implement.

10. The system of claim 8, wherein the monitoring device is a smart device or a dedicated monitoring device.

11. The system of claim 8, wherein the monitoring device comprises a transducer and a processor, wherein the transducer receives the sound generated by the powered oral care (POC) implement, converts the sound into a signal representative of the sound, and transmits the signal to the processor.

12. The system of claim 11, wherein the processor comprises a compressor, and automatic gain control (AGC), an averaging circuit, and a detection circuit, wherein:
the compressor receives the signal representative of the sound and produces a compressed signal such that the compressor attenuates an amplitude of the signal when above a compressor threshold;
the automatic gain control (AGC) receives the compressed signal and produces a gain-adjusted signal such that an amplitude of the gain-adjusted signal is within an automatic gain control (AGC) amplitude range based on an automatic gain control (AGC) time period;
the averaging circuit receives the gain-adjusted signal and determines an average amplitude of the sound based on an averaging time period; and
the detection circuit receives the average amplitude and determines whether the powered oral care (POC) implement is switched on by determining whether the average amplitude exceeds an amplitude threshold for at least a minimum threshold duration period.

13. The system of claim 11, wherein the transducer comprises a microphone and an analog-to-digital converter, and the processor comprises a microprocessor, wherein:
the microphone receives the sound generated by the POC implement, converts the sound to an analog signal representative of the sound, and transmits the analog signal to the analog-to-digital converter;
the analog-to-digital converter converts the analog signal to a digital signal and transmits the digital signal to the microprocessor; and
the microprocessor determines the one or more characteristics of the powered oral care (POC) implement based on the digital signal.

14. The system of claim 8, wherein the sound generated by the powered oral care (POC) implement is generated by the an actuator of the powered oral care (POC) implement, a dedicated acoustic device, or a combination thereof.

15. A method for determining one or more characteristics of a powered oral care (POC) implement, the method comprising:
receiving sound generated by the powered oral care (POC) implement;
identifying one or more acoustic characteristics of the sound; and
determining one or more characteristics of the powered oral care (POC) implement based on the one or more acoustic characteristics of the sound.

16. The method of claim 15, wherein the one or more characteristics of the powered oral care (POC) implement include at least one selected from the group consisting of:
whether the powered oral care (POC) implement is switched on or off;
an amount of time the powered oral care (POC) implement is used to clean teeth;
an amount of pressure applied by the powered oral care (POC) implement to teeth;
a manufacturer of the powered oral care (POC) implement;
a model number of the powered oral care (POC) implement; and
a brushing mode of the powered oral care (POC) implement.

17. The method of claim 15, wherein the identifying one or more acoustic characteristics of the sound comprises identifying a particular amplitude of the sound, identifying a particular frequency of the sound, or a combination thereof.

18. The method of claim 15, wherein the identifying one or more acoustic characteristics of the sound comprise identifying an average amplitude of the sound based on an averaging time period.

19. The method of claim 18, wherein the determining one or more characteristics of the powered oral care (POC) implement comprises determining whether the powered oral care (POC) implement is switched on by determining whether the average amplitude of the sound exceeds an amplitude threshold for at least a minimum threshold duration period.

20. The method of claim 15, wherein determining one or more characteristics of the powered oral care (POC) implement comprises determining whether an amplitude of the sound is above an amplitude threshold, whether a frequency of the sound is within a frequency range, or a combination thereof.
